(19) United States
(12) Patent Application Publication
(10) Pub. No.: US 2010/0186013 A1
(43) Pub. Date: Jul. 22, 2010

(54) Controlling Access to a Shared Resource in a Computer System

(75) Inventor: Rob HARROP, Southampton (GB)

Correspondence Address: VMWARE, INC., DARRYL SMITH, 3401 Hillview Ave., PALO ALTO, CA, 94304, US

(73) Assignee: VMWARE, INC., Palo Alto, CA (US)

(21) Appl. No.: 12/609,315

(22) Filed: Oct. 30, 2009

Related U.S. Application Data
(60) Provisional application No. 61/164,020, filed on Mar. 27, 2009.

(30) Foreign Application Priority Data
Jan. 16, 2009 (GB) 0900708.9

(51) Int. Cl. G06F 9/46

(52) U.S. Cl. 718/100

(57) ABSTRACT

A computer system and method are provided that control access to shared resources using a plurality of locks (e.g. mutex locks or read-write locks). A locking unit grants the locks to a plurality of threads of execution of an application in response to lock access requests. A guardian unit monitors the lock access requests and records the locks that are granted to each of the threads. The guardian unit selectively blocks the lock access requests when, according to a predetermined locking protocol, a requested lock must not be acquired after any of the locks which have already been granted to the requesting thread.

### CROSS REFERENCE TO RELATED APPLICATION(S)

This application claims the benefit of U.S. Provisional Application No. 61/164,020 filed on Mar. 27, 2009. This application also claims the benefit of UK Patent Application No. 0900708.9 filed on Jan. 16, 2009.

### BACKGROUND

1. Technical Field

The present invention relates generally to the field of computers and computer systems. More particularly, the present invention relates to a method and apparatus for controlling access to a shared resource in a computer system.

2. Description of Related Art

Modern computing systems have become highly sophisticated and complex machines, which are relied upon to perform a huge range of tasks in all our everyday lives. These computer systems comprise a multitude of individual components and sub-systems that must all work together correctly. In particular, multitasking computer architectures have been developed that support more than one thread of execution concurrently in order to perform more than one task at a time. Usually, such systems employ multiprocessor computer architectures having two or more central processor units (also called “CPUs” or simply “processors”), and these multiple processors then execute the multiple threads.

Such multitasking computer systems can be arranged to perform very large and complex workloads. Thus, creating programs to execute on these systems is a difficult and challenging task. In particular, the application programs that run on these modern computing systems have become increasingly complex and are increasingly difficult to develop. This leads to very lengthy development and deployment cycles and/or leads to errors (e.g. crashes) when the computer systems execute the application programs under a live load and serving real users. It is helpful to improve the stability and reliability of such computer systems. Also, it is helpful to reduce the workload which is involved in developing new applications to be used by such computer systems. Further, it is helpful to adapt the computer systems to be more tolerant of errors and mistakes.

A multitasking computer system typically includes a lock management unit which provides locks that control access to shared resources. Commonly, the locks are used to enforce a mutual exclusion property, whereby only one thread of execution has access to a particular shared resource, to the exclusion of all other threads. Hence, these locks are usually termed mutual exclusion (or “mutex”) locks. Similarly, read-write locks are used to control read and write privileges for a shared resource. Usually, read locks will be granted to multiple threads simultaneously, provided that no other thread currently has a write lock on the same shared resource. A thread can acquire the write lock if no other thread owns either a read lock or a write lock on that shared resource.

The computer system will often need to employ a plurality of locks to control access to various different parts of the shared resources in the computer system, such as different data locations of a large database or different pages of memory. However, the computer system is vulnerable to errors that arise in relation to the locks, one of which is known as a deadlock condition. Typically, a deadlock arises because two or more threads each try to access a shared resource, but each thread is waiting for another to release one of the locks. As a result, the ordinary flow of execution comes to a halt and the computer system does no further useful work until the deadlock condition is cleared.

It is very difficult to predict in advance whether a particular computer program is vulnerable to deadlocks. Even the most careful testing of the program code cannot completely eliminate the possibility of a deadlock, mainly because the testing process cannot simulate all of the real-world conditions that may arise later while executing the program under a live load.

The example embodiments have been provided with a view to addressing at least some of the difficulties that are encountered in current computer systems, whether those difficulties have been specifically mentioned above or will otherwise be appreciated from the discussion herein.

### SUMMARY

According to the present invention there is provided a computer system, a method and a computer-readable storage medium as set forth in the appended claims. Other, optional, features of the invention will be apparent from the dependent claims, and the description which follows.

At least some of the following example embodiments provide an improved mechanism for controlling access to a shared resource in a computer system. Also, at least some of the following example embodiments provide an improved mechanism for testing whether a computer system is vulnerable to deadlocks.

There now follows a summary of various aspects and advantages according to embodiments of the invention. This summary is provided as an introduction to assist those skilled in the art to more rapidly assimilate the detailed discussion herein and does not and is not intended in any way to limit the scope of the claims that are appended hereto.

Generally, a computer system is provided which includes an execution environment that supports a plurality of threads and at least one shared resource that, in use, is accessed by the plurality of threads. A locking unit holds a plurality of locks which guard access to parts of the shared resource, wherein the locking unit grants the locks to the threads in response to lock access requests, and wherein the thread which has been granted a combination of the plurality of locks gains access to the respective parts of the shared resource. A guardian unit monitors the lock access requests and records the locks that are granted to each of the threads, wherein the guardian unit selectively blocks the lock access requests when, according to a predetermined locking protocol, a requested lock must not be acquired after any of the locks which have already been granted to the requesting thread.

In one example aspect, the locks are mutual exclusion locks and/or read-write locks.

In one example aspect, the guardian unit selectively allows the lock access requests when, according to the locking protocol, the requested lock is permitted to be acquired after each of the locks which have already been granted to the requesting thread.

In one example aspect, the guardian unit records the granted locks in a lock allocation table and compares the requested lock against the locks which, according to the lock allocation table, have already been granted to the requesting thread.

In one example aspect, the guardian unit is configured to receive a locking protocol definition from at least one of the plurality of the threads to define the locking protocol in relation to the plurality of locks.

In one example aspect, the locking protocol definition declares the plurality of locks and comprises locking information that defines an ordering of the plurality of locks.

In one example aspect, the guardian unit provides an application programming interface which receives the lock access requests from the plurality of threads.

In one example aspect, the guardian unit is arranged inline with the locking unit and selectively blocks the lock access requests from the at least one of the plurality of threads or else passes the lock access requests to the locking unit.

In one example aspect, the guardian unit is integrated with the locking unit.

In one example aspect, the plurality of threads include one or more threads related to an application program and one or more threads related to external code that is external to the application program.

In one example aspect, the guardian unit is arranged to hold a plurality of the locking protocols, each of which relates to a corresponding plurality of the locks.

In one example aspect, the guardian unit is arranged to raise an exception when the requested lock is not consistent with the locking protocol.

In one example aspect, the computer system further comprises a management console unit that produces an error report in response to the exception, wherein the error report identifies the requesting thread, the requested lock, and the locks which have already been granted to the requesting thread.

In one example aspect, the computer system further comprises a testing tool arranged to exercise one or more code paths within an application program and to compare the lock access requests which arise on the one or more code paths against the predetermined locking protocol.

Generally, a method is provided for controlling access to a shared resource in a computer system. The method includes defining a locking protocol in relation to a plurality of locks that control access to the shared resource by a plurality of threads of execution of the computer system. A lock access request is received from one of the threads in relation to a requested lock amongst the plurality of locks. The method then selectively blocks the lock access request where, according to the locking protocol, the requested lock must not be granted after any of the locks which have already been granted to that thread. Otherwise, the method comprises granting the requested lock to the thread and recording that the requested lock has been granted to the thread. Then, the method comprises repeating the receiving and selectively blocking (or granting) steps for further lock access requests made by any of the plurality of threads in relation to any of the plurality of locks.

Generally, a computer-readable storage medium is provided having recorded thereon instructions which, when implemented by a computer system, cause the computer system to be arranged as set forth herein and/or which cause the computer system to perform the method as set forth herein.

At least some embodiments of the invention may be constructed, partially or wholly, using dedicated special-purpose hardware. Terms such as ‘component’, ‘module’ or ‘unit’ used herein may include, but are not limited to, a hardware device, such as a Field Programmable Gate Array (FPGA) or Application Specific Integrated Circuit (ASIC), which performs certain tasks. Alternatively, elements of the invention may be configured to reside on an addressable storage medium and be configured to execute on one or more processors. Thus, functional elements of the invention may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Further, although the example embodiments have been described with reference to the components, modules and units discussed below, such functional elements may be combined into fewer elements or separated into additional elements.

### BRIEF DESCRIPTION OF THE DRAWINGS

For a better understanding of the invention, and to show how example embodiments may be carried into effect, reference will now be made to the accompanying drawings in which:

FIG. 1 is a schematic overview of an example computer network in which the example embodiments may be applied;

FIG. 2 is a schematic overview of a computer system according to an example embodiment of the present invention;

FIG. 3 is a schematic diagram illustrating the example computer system under a deadlock condition;

FIG. 4 is a schematic diagram illustrating the example computer system in more detail;

FIG. 5 is a schematic diagram illustrating the example computer system while controlling access to a shared resource;

FIG. 6 is a schematic diagram illustrating the example computer system when preventing a deadlock condition;

FIG. 7 is a schematic diagram illustrating further aspects of the example computer system in more detail;

FIG. 8 is a schematic diagram illustrating another aspect of the example computer system in more detail; and

FIG. 9 is a schematic flowchart of an example method of controlling access to a shared resource in a computer system.

### DETAILED DESCRIPTION

The example embodiments of the present invention will be discussed in detail in relation to Java, Spring and so on. However, the teachings, principles and techniques of the present invention are also applicable in other example embodiments. For example, embodiments of the present invention are also applicable to other virtual machine environments and other middleware platforms, which will also benefit from the teachings herein. For example, the example embodiments are also applicable to other runtime environments that support locks, such as Java, C++, C# and Ruby, amongst others.

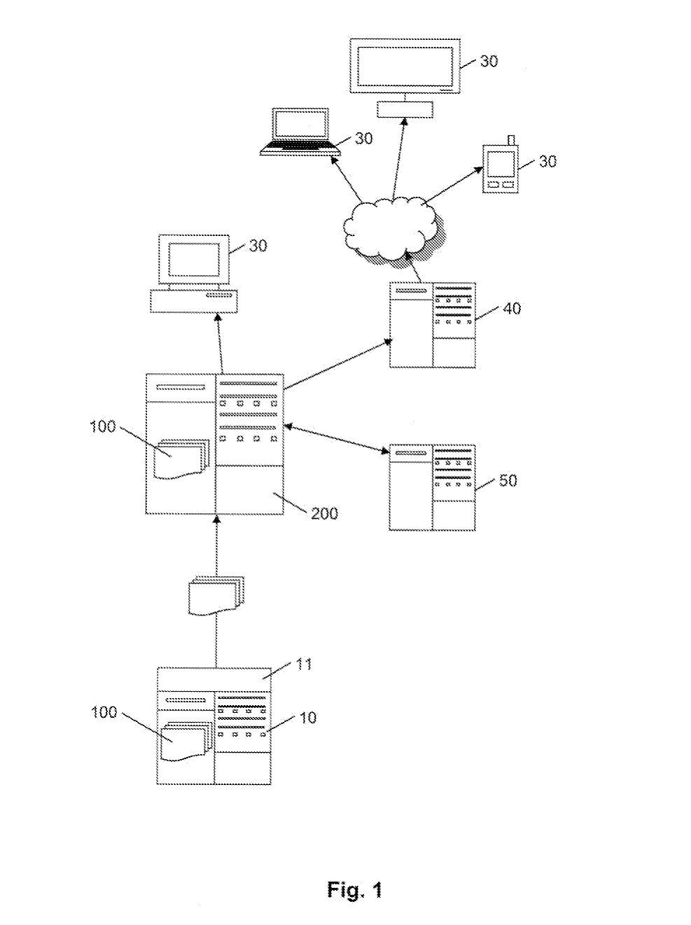

FIG. 1 is a schematic overview of an example computer network in which the example embodiments discussed herein are applied. An application program 100 is developed on a development system 10 and is tested by a variety of testing tools 11. The finished application 100 is then deployed onto one or more host computer systems 200, using a suitable deployment mechanism. The application 100 runs (executes) on the host computer system 200 and, in this example, serves one or more individual end-user client devices 30 either over a local network or via intermediaries such as a web server 40. When running the application 100, the host computer system 200 will often communicate with various other back-end computers such as a set of database servers 50. FIG. 1 is only an illustrative example and many other specific network configurations will be apparent to those skilled in the art.

The application program 100 is typically developed using object-oriented programming languages, such as the popular Java language developed by Sun Microsystems. Java relies upon a virtual machine which converts universal Java bytecode into binary instructions in the instruction set of the host computer system 200. More recently, Java 2 Standard Edition (J2SE) and Java 2 Enterprise Edition (JEE or J2EE) have been developed to support a very broad range of applications from the smallest portable applets through to large-scale multilayer server applications such as complex controls for processes, manufacturing, production, logistics, and other industrial and commercial applications.

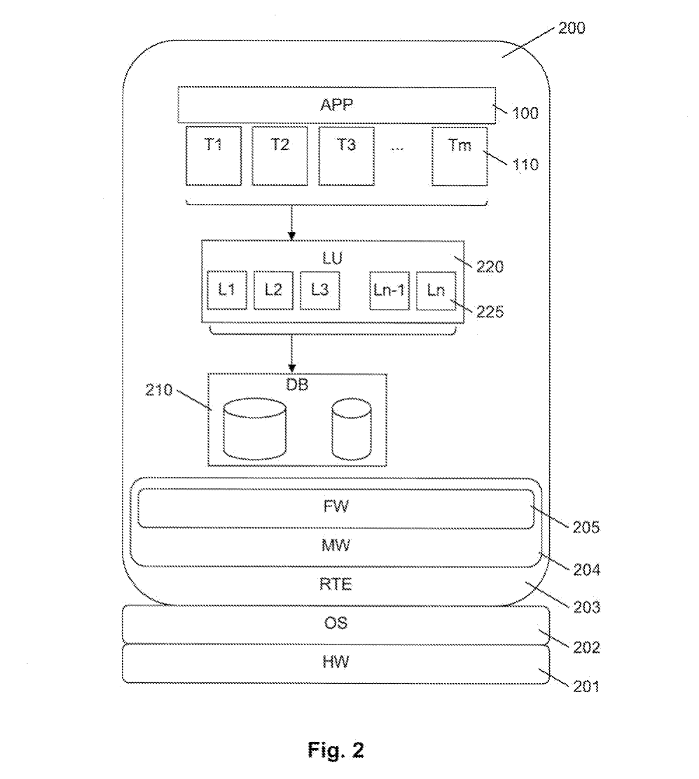

FIG. 2 is a schematic overview of a computer system 200 according to an example embodiment of the present invention. In this example, the host computer system 200 includes physical hardware (HW) 201 such as memory, processors, I/O interfaces, backbone, power supply and so on as are found in, for example, a typical server computer; an operating system (OS) 202 such as Windows, Linux or Solaris; and a runtime environment (RTE) 203 such as Microsoft .NET or Java (e.g. Hotspot or Java 1.5). The runtime environment 203 supports a multitude of components, modules and units that coordinate to perform the actions and operations that are required of the computer system 200 to support execution of the application program 100.

In the example embodiments, the host computer 200 also includes a middleware layer (MW) 204. This middleware layer 204 serves as an intermediary between the application program 100 and the underlying layers 201-203 of the host computer 200 with their various different network technologies, machine architectures, operating systems and programming languages. In the illustrated example, the middleware layer 204 includes a framework layer 205, such as a Spring framework layer. Increasingly, applications are developed with the assistance of middleware such as the Spring framework. The application 100 is then deployed onto the host computer system 200 with the corresponding framework layer 205, which supports the deployment and execution of the application 100 on that computer system 200.

As shown in FIG. 2, the application (APP) 100 includes a plurality of separate threads of execution 110, which are illustrated by threads T1, T2, etc. The application may have several such threads (e.g. m threads, where m is a positive integer) which execute concurrently on the host computer system 200. In general, these multiple threads 110 exist simultaneously within the computer system 200 and execute on the processors of the hardware 201 to perform useful work and derive real-world outcomes from the computer system. Depending upon the configuration of the computer system, these threads of execution may be provided as independent tasks (i.e. completely separate programs), as separate but related processes within a single program, or as closely related threads within a single process.

The host computer system further includes at least one a shared resource 210. Typically, the computer system 200 includes many such shared resources 210, which are each accessible by two or more of the threads of execution 110. In one example, the shared resource 210 is a database (DB) through which the application 100 passes a large number of transactions. In another example, the shared resource 210 is a shared memory area which the application 100 accesses frequently. However, the exact nature of the shared resource 210 is not particularly relevant to the discussion herein and the shared resource may take any suitable form as will be familiar to those skilled in the art.

A locking unit (LU) 220 defines a plurality of locks 225 (L1, L2, etc.) which control access to the shared resource 210 by the plurality of threads 110. For example, the locks 225 are mutex locks or read-write locks. The locking unit 220 may define several such locks 225 (e.g. n locks, where n is a positive integer). In use, the locking unit 220 grants the locks L1, L2 to the threads T1, T2 in response to lock access requests made by the threads 110 to the locking unit 220. Each lock access request is made by a requesting thread and specifies one or more requested locks. For example, the thread “T1” requests the lock “L1”. In response to such a lock access request, the locking unit 220 either grants the requested lock L1 to the requesting thread T1 or, if the requested lock L1 is already granted to another thread, the requesting thread T1 now waits until the requested lock L1 is free before continuing.

In one example, the locking unit 220 operates similar to the Java locking API that will be familiar to the skilled person. More detailed background information is available, for example, at http://java.sun.com/j2se/1.5.0/docs/api/java/util/concurrent/locks/Lock.html.

Typically, each of the locks 225 gives access to a particular part of the shared resource 210, while that thread owns the lock. However, the thread will commonly need to access multiple parts of the shared resource in order to complete a particular function. Thus, it is common for the thread T1 to obtain a plurality of the locks 225 in combination before proceeding further.

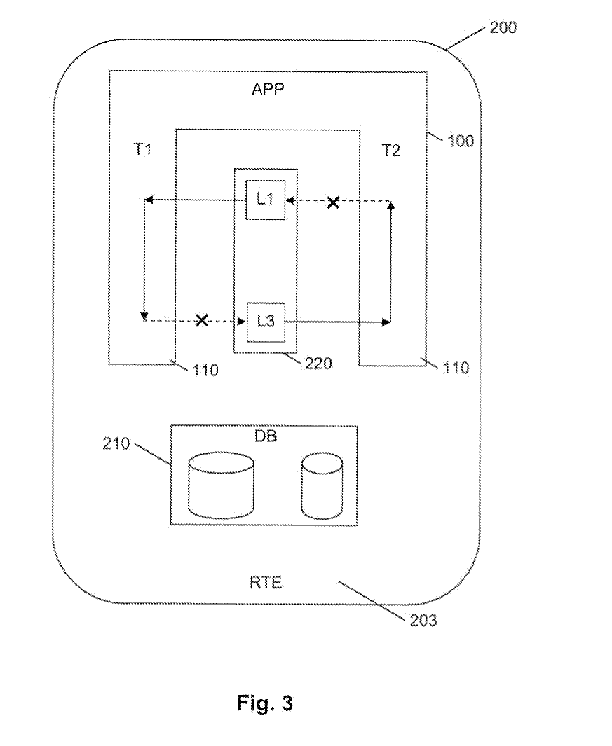

FIG. 3 is a schematic diagram illustrating the computer system 200 under a deadlock condition. In this example, the thread T1 requires a set of locks L1 and L3 in order to perform a desired function with respect to the shared resource 210. However, another thread T2 also attempts to access the shared resource 210 and seeks control of some of these locks (e.g. locks L1 & L3) in common with the thread T1. Due to the vagaries of concurrent execution within the computer system, each of the threads T1 & T2 has obtained one or more of the locks it needs but is now waiting for the remaining locks to come free (known as “hold-and-wait”). In FIG. 3, thread T1 holds lock L1 and is waiting for L3. Meanwhile, thread T2 holds lock L3 and is waiting for L1. Thus, a circular stalemate arises and neither thread can proceed due to the deadlock.

In this case, the ordinary flow of execution comes to a halt and the computer system does no further useful work until the deadlock condition is cleared. Typically, the operating system detects the deadlock condition and takes remedial action, such as stopping one thread and releasing its granted locks so that the other thread may then continue. Alternatively, the computer system simply hangs until a manual intervention by an administrator or operator. Deadlocks are a danger to the computer system and in many practical situations it is highly desirable that such a deadlock condition does not arise.

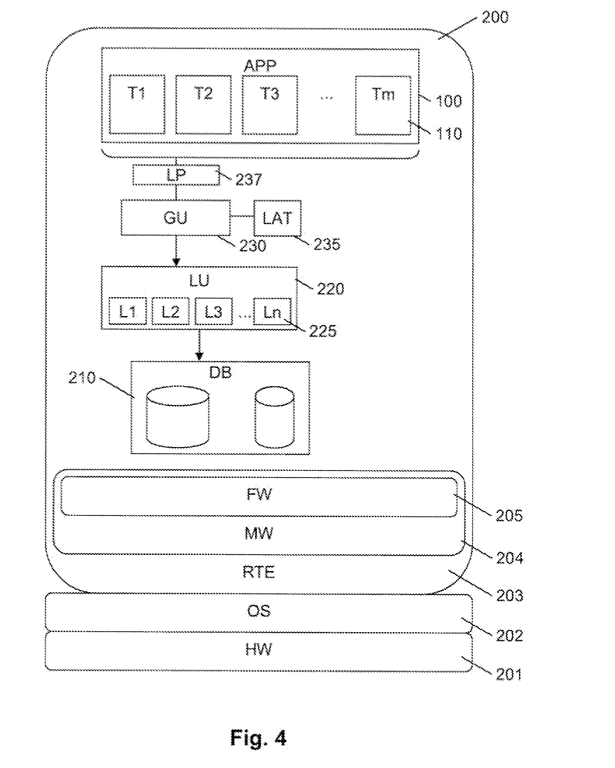

FIG. 4 is a schematic diagram illustrating the example computer system 200 in more detail. Here, the illustrated computer system 200 has an improved mechanism for controlling access to a shared resource 210.

As shown in FIG. 4, the example computer system 200 further comprises a guardian unit (GU) 230 that is arranged to enforce a locking protocol (LP) 237.

In one example embodiment, the guardian unit 230 is provided offline and cooperates with the locking unit 220 by messaging, such as by authenticating the lock access requests in the lock guardian unit 230 prior to the lock access requests then being sent to the locking unit 220 by the application 100.

In another example embodiment, the guardian unit 230 is arranged inline with the locking unit 220, so that calls to the locking unit 220 first pass through the guardian unit 230. Thus, at least those lock access requests that are made during critical sections of the application 100 first pass through the guardian unit 230 before reaching the locking unit 220. Suitably, the guardian unit 230 is arranged as an application programming interface (API). In one embodiment, the guardian unit 230 supplants a regular API provided by the locking unit 220. Thus, the application 100 calls to the API of the guardian unit 230, and the guardian unit 230 selectively passes those calls into the locking unit 220. This arrangement conveniently allows the guardian unit 230 to perform the blocking and monitoring functions discussed herein.

In yet another embodiment, the guardian unit 230 is incorporated with the locking unit 220 to form one combined unit. That is, the locking unit 220 is arranged to incorporate the functions of the guardian unit 230, or vice versa.

Conveniently, the guardian unit 230 is delivered onto the computer system 200 as a class library so as to be available to the application 100 as part of the runtime execution environment 203. In one example, the class library containing the guardian unit 230 is provided as part of the framework layer 205.

Suitably, the application program 100 calls to the guardian unit 230 to declare the locking protocol 237. That is, the guardian unit 230 first receives a declaration from the application 100 that defines the set of locks and gives locking information that enables an order of those locks to be established. For example, the application 100 declares the locking protocol 237 by defining the set of locks as comprising locks labelled “L1”, “L2” and “L3” and implicitly or explicitly defines an order of the locks, such as L1>L2>L3.

Example 1 below is a pseudocode example of the locking protocol definition made by the application 100 to the guardian unit 230,

### Example 1

```
create locking protocol P1
add lock L1 to protocol P1
add lock L2 to protocol P1
add lock L3 to protocol P1
request lock L1
if successful then
  request lock L2
  if successful then
    perform actions under lock L1 and lock L2
    release lock L2
  release lock L1
```

In Example 1, the order in which the locks are added to the locking protocol implicitly determines their ordering within this protocol. That is, the set of locks that are needed by some critical section of the application 100 are made to follow a predetermined order or hierarchy according to the locking protocol 237. As one example, the guardian unit 230 assigns a numerical weighting to each lock 225 and then arranges the locks 225 in numerical order. In other words, an ordering relation is defined so that, for any given pair of the locks, one lock must be acquired before or, conversely, may not be acquired after, the relevant other lock. This pair-wise relation then applies between each of the plurality of locks 225 which are protected by the locking protocol 237. The locks 225 can also be considered as a totally ordered set.

In practical embodiments of the computer system 200, the guardian unit 230 may hold multiple locking protocols 237 (such as P1, P2, etc.), each of which relates to a corresponding set of the locks 225.

In use, the guardian unit 230 monitors the lock access requests made by the threads 110 to the locking unit 220. The guardian unit 230 records which of the locks 225 are granted to each of the threads 110. In one example embodiment, the guardian unit 230 records the granted or allocated locks 225 in a lock allocation table (LAT) 235.

The guardian unit 230 blocks a lock access request where the requested lock is not consistent with the locking protocol 237. That is, the guardian unit 230 acts to selectively deny the lock access requests. In the example embodiment, the guardian unit 230 selectively blocks the lock access requests when, according to the predetermined ordering of the locking protocol 237, the requested lock must be acquired before (may not be acquired after) any of the locks which have already been granted to the requesting thread. Conversely, the guardian unit 230 selectively allows the lock access requests to proceed when, according to the locking protocol 237, the requested lock is permitted to be acquired with respect to the one or more locks have already been granted to the requesting thread.

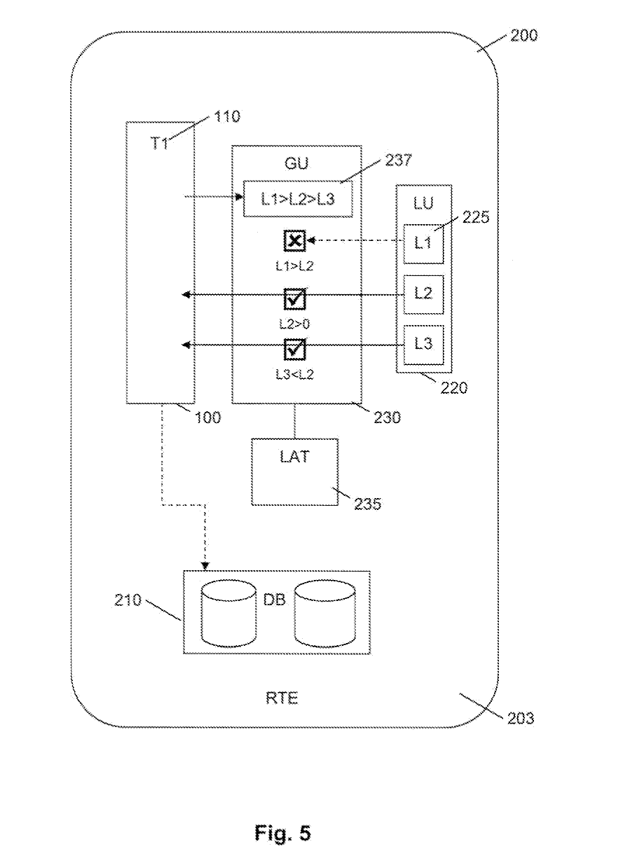

As a specific example, FIG. 5 shows the locking unit 220 with a set of locks L1, L2 and L3. According to the locking protocol 237 held by the guardian unit 230, these locks are arranged in a predetermined order or hierarchy so that L1>L2>L3, where the symbol “>” means the inequality relation “greater than”. These locks are now mutually comparable according to the “greater than” relation, to determine where each lock resides in the predetermined order with respect to each of the other locks in the set.

In use, the thread T1 makes a lock access request in relation to lock L2. The guardian unit 230 determines (e.g. from the lock access table 235) that no locks have been granted to this thread T1 previously and so allows the lock access request to proceed. The locking unit 220 grants the requested lock L2 to the requesting thread T1, and the guardian unit 230 then updates the LAT 235 to record that the thread T1 has been granted the lock L2.

Continuing this specific example, the thread T1 now requests the lock L3. Here, the guardian unit 230 determines that the lock access request complies with the predetermined order of the locking protocol, because the lock L2 must be granted to the requesting thread T1 before the lock L3 is acquired. In other words, the requested lock L3 is inferior to the previously granted lock L2 in the hierarchy of the set and therefore this request is consistent with the locking protocol. As a result, the guardian unit 230 again does not block the lock access request and the requested lock L3 may be granted to the requesting thread T1 by the locking unit 220.

The thread T1 now makes a lock access request in relation to lock L1. In response, the guardian unit 230 compares the requested lock against each of those locks that previously have been granted to that thread. In this example, the lock allocation table 235 records that the locks L2 and L3 have already been granted to thread T1. However, this time, the comparison made by the guardian unit 230 determines that the requested lock L1 is not consistent with the locking protocol, because the lock L1 may only be obtained before (must not be obtained after) the locks L2 and L3. Therefore, the guardian unit 230 blocks the lock access request in relation to the lock L1 and, as a result, the requested lock L1 is not granted to the requesting thread T1. The guardian unit 230 thus forces the thread T1 to obtain the locks L1, L2 and L3 in a temporal sequence consistent with the predetermined order of the locking protocol 237.

This mechanism is flexible in that the locking protocol 237 allows the threads 110 to obtain any subset of the locks 225 that are needed at a particular point in the application 100 or for a particular function in the application 100. For example, the locking protocol 237 allows the thread T1 to obtain just the locks L1 and L2. Then, later, the same locking protocol 237 still applies even when a different combination of these locks are needed by the thread. For example, the same thread may instead obtain just the locks L1 and L3, without requiring any amendment or revision of the locking protocol.

In one example embodiment, the locking protocol enforces a strict ordering, whereby the plurality of locks may only be obtained exactly in the predetermined order (e.g. lock L1 must be followed exactly by lock L2 which in turn must be followed exactly by L3). However, this strict ordering is restrictive and may require frequent revisions to the definition of the locking protocol 237.

In the example embodiments, the guardian unit 230 enforces the locking protocol not only for the thread 110 that declared the protocol, but also for any other threads in the runtime execution environment that may attempt to obtain any of the protected set of locks 225.

Suitably, the guardian unit 230 is arranged to intercede in relation to all lock requests in respect of the identified set of locks 225. That is, the guardian unit 230 monitors and selectively blocks the lock access requests that are made by any executing thread 110 in relation to the protected set of locks (which in this example is the set of locks labelled “L1”, L2” and “L3”). A deadlock condition that might otherwise arise due to the timing effects as between a plurality of threads is now easily avoided by forcing all of the threads T1, T2, etc. to follow this same locking protocol 237 in relation to this set of locks 225.

Suitably, the guardian unit 230 enforces the locking protocol also on threads that relate to external code, such as third-party libraries or other application programs, which are present on the host system 200 when executing the application 100. Importantly, this external code may not have been available on the development system 10 where the application was originally developed and thus there has been no opportunity previously to test an interaction of the application 100 with this external code. However, the example computer system 200 is now more reliable in executing the application 100, even in combination with external code.

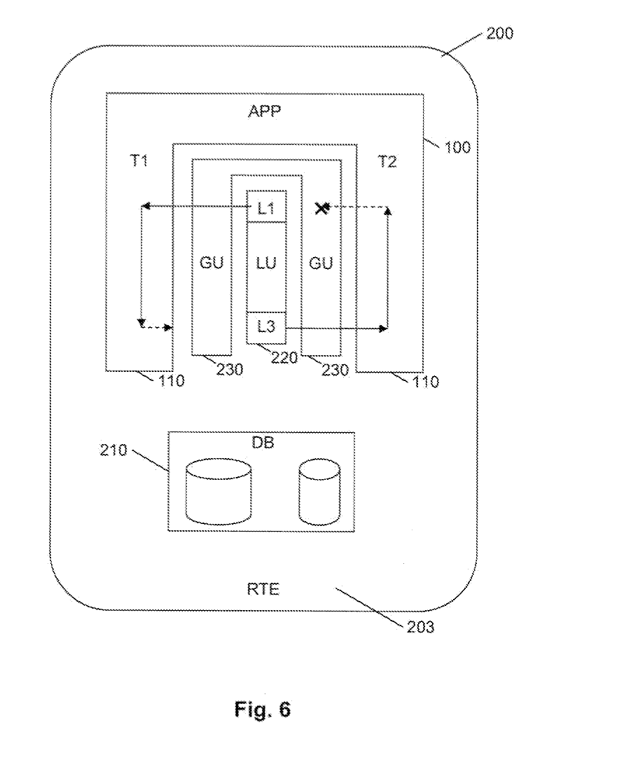

FIG. 6 now shows the example situation discussed above in FIG. 3, but in this case the deadlock condition is avoided. As discussed previously, the thread T1 holds the lock L1 and now needs the lock L3. Meanwhile, the thread T2 holds the lock L3 and now needs the lock L1. However, when thread T2 makes a lock access request in relation to the lock L1, the lock guardian unit 230 applies the predetermined locking protocol and determines that the request for L1 is not consistent with the locking protocol 237, because the thread T2 already holds the lower-ranked lock L3. The request for L1 is therefore not consistent with the correct order and is blocked. The deadlock condition is therefore avoided.

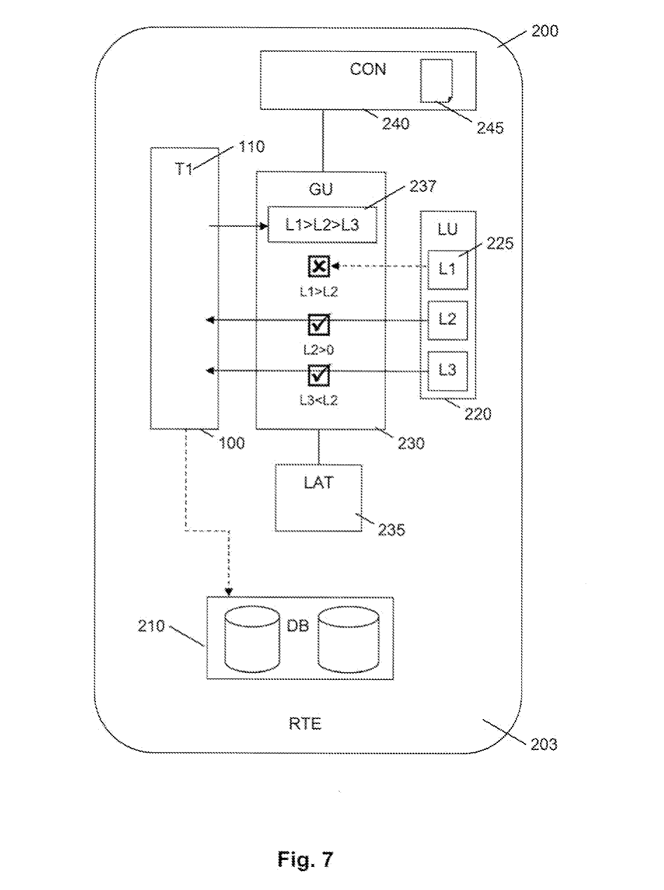

FIG. 7 is a schematic diagram illustrating the example computer system 200 in more detail. In this example embodiment, the guardian unit 230 is further arranged to cause an exception in the event that the locking protocol 237 is broken. The exception identifies that a potentially dangerous lock access request has occurred and a remedial action can now be taken without delay.

For example, as the remedial action, execution of the requesting thread T2 is stopped and the situation cleared immediately, such as by rolling back the execution of thread T2 to a well-defined recovery point, clearing any locks granted to thread T2, and scratching any data changes back to their state at that recovery point. Thread T2 may then restart execution form the recovery point. Meanwhile, thread T1 now obtains the remaining desired lock L1 and achieves its desired access to the shared resource 210. However, this is only one example and many other specific remedial actions will be apparent to those skilled in the art based on this general discussion.

Suitably, the exception is reported to a management console unit (CON) 240, which in one example is provided using Java Management Extensions or JMX. The management console 240 suitably produces an error report 245 that records the reason for the exception and the relevant status of the system. The error report 245 is helpful, for example, in a later analysis or debugging of the system. Continuing with the example illustrated in FIG. 6, the example error report 245 identifies that thread T2 caused the exception by requesting lock L1. Also, the error report suitably reports the status of the granted locks at this point, based on the lock allocation table 235.

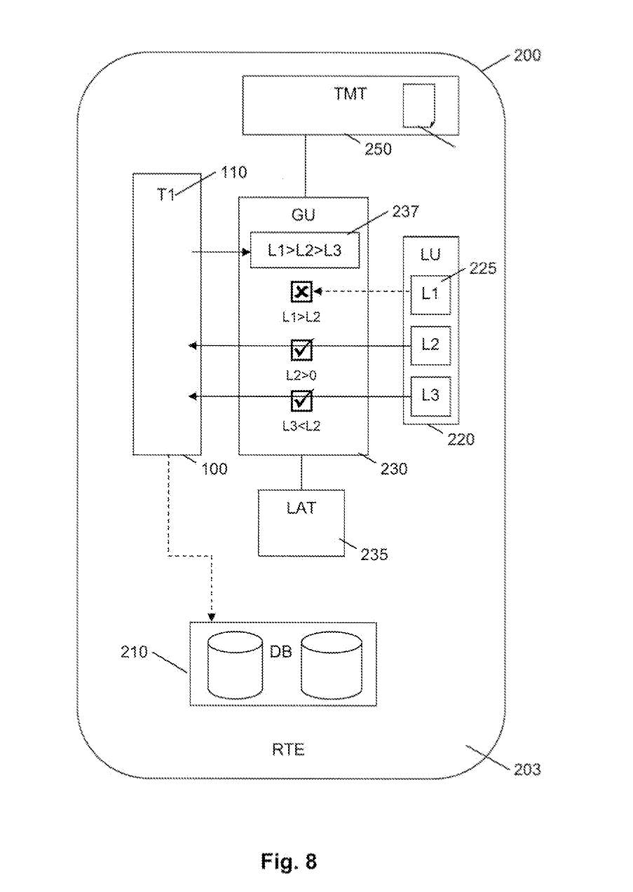

FIG. 8 is a schematic diagram illustrating a further aspect of the example computer system 200 in more detail. Here, the computer system 200 comprises a testing and management tool (TMT) 250 for testing the program code 100 prior to execution. Suitably, the guardian unit 230 is closely integrated with the testing and management tool 250, and they may be formed together as one unit. In an example embodiment, the testing and management tool 250 is provided using JMX. The testing and management tool 250 may also be provided as one of the tools 11 on the development system 10 of FIG. 1. Here, the tool 250 enables the development system 10 to produce the application 100 in a more reliable form and thus reduces the likelihood of errors or fatal crashes of the host system 200.

In a testing phase, the tool 250 is applied to methodically exercise each code path in the application 100. Each lock access request is inspected by the guardian unit 230 to determine whether any of the requested locks are being monitored by any one or more of the predetermined locking protocols 237, and further whether such lock access request is indeed consistent with the respective predetermined locking protocol 237. This inspection is deterministic, in that any attempt to break the lock ordering defined in the protocol 237 will be detected. Also, the same error will be detected each time that section of code is examined. Thus, the tool 250 reliably inspects the code. Any deviation from the defined locking protocol 237 is reported as a potential deadlock error. The test may be applied to one thread at a time and, by examining that thread alone, conformity with the locking protocol 237 is confirmed for that thread independently. The test then proceeds to the next thread, until all of the necessary code paths have been traversed.

If the code successfully passes the inspection, i.e. without reporting any locking protocol errors, there is a high confidence that deadlocks will not arise at run time, even under a live load, because all of the threads independently adhere to the defined locking protocol 237 for the relevant set of locks.

Of course, there is still the possibility that timing effects or interactions with other untested code (such as legacy code or libraries) will give rise to an unintended deadlock. However, the guardian unit 230 then operates to control access to the shared resource 210 as a run-time protection against deadlocks, as described above. Thus, as one option, the testing tool 250 and the guardian unit 230 may be implemented separately and independent of each other.

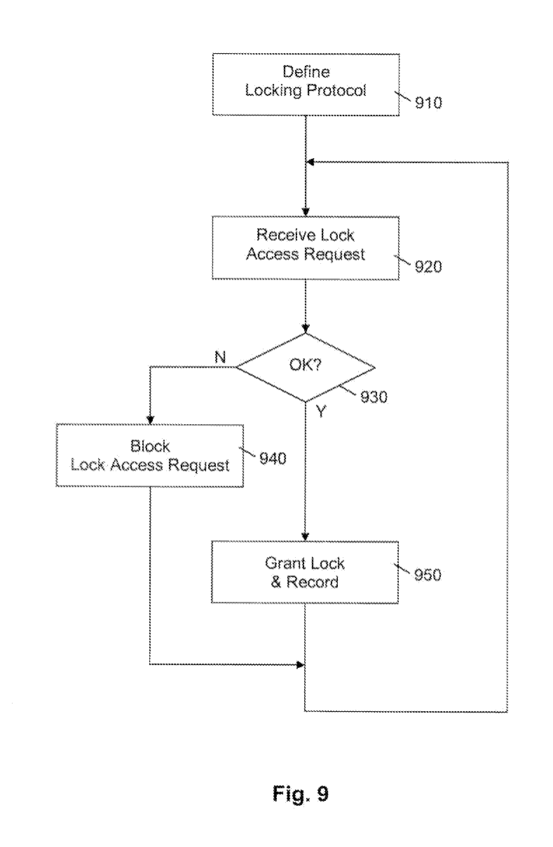

FIG. 9 is a schematic flowchart of an example method of controlling access to a shared resource in a computer system.

In step 910, at least one of the threads 110 defines the locking protocol 237 in relation to a set of locks 225 that control access to the shared resource 210. In step 920, a lock access request is received from one of the threads 110 in relation to a requested lock amongst the plurality of locks 225. Conveniently, the method includes the step 930 of comparing the requested lock against those locks which have already been granted to that thread, to determine whether the lock access request is consistent with the locking protocol 237. In step 940, this lock access request is selectively blocked where, according to the locking protocol 237, the requested lock must not be granted after any of the locks which have already been granted to that thread. Otherwise, in the step 950, the requested lock is granted to the thread and a record is made that the requested lock has been granted to the thread. The method now repeats the receiving, comparing and selectively blocking or granting steps for any and all further lock access requests that are made by any of the plurality of threads 110 in relation to any of the plurality of locks 225 in the set that are protected by this locking protocol 237. Further details of the method have already been described above. For example, the method may operate as a testing procedure such as during development of an application program, or may operate as a runtime protection procedure when the application program is executed on a host computer system.

In summary, the example embodiments have described an improved mechanism to control access to a shared resource within a computer system. The industrial application of the example embodiments will be clear from the discussion herein.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A computer system, comprising:
an execution environment that supports a plurality of threads;
a shared resource that is accessed by the plurality of threads;
a locking unit that holds a plurality of locks which control access to parts of the shared resource, wherein the locking unit grants the locks to the threads in response to lock access requests, and wherein the thread which has been granted a combination of the plurality of locks gains access to the respective parts of the shared resource; and
a guardian unit that monitors the lock access requests and records the locks that are granted to each of the threads, wherein the guardian unit selectively blocks the lock access requests when, according to a predetermined locking protocol, a requested lock must not be acquired after any of the locks which have already been granted to the requesting thread.

2. The computer system of claim 1, wherein the guardian unit selectively allows the lock access requests when, according to the locking protocol, the requested lock is permitted to be acquired after each of the locks which have already been granted to the requesting thread.

3. The computer system of claim 1, wherein the guardian unit records the granted locks in a lock allocation table and compares the requested lock against the locks which, according to the lock allocation table, have already been granted to the requesting thread.

4. The computer system of claim 1, wherein the guardian unit is configured to receive a locking protocol definition from at least one of the plurality of the threads to define the locking protocol in relation to the plurality of locks.

5. The computer system of claim 4, wherein the locking protocol definition declares the plurality of locks and comprises locking information that defines an ordering of the plurality of locks.

6. The computer system of claim 1, wherein the guardian unit provides an application programming interface which receives the lock access requests from the plurality of threads.

7. The computer system of claim 1, wherein the guardian unit is arranged inline with the locking unit and selectively blocks the lock access requests from the at least one of the plurality of threads or else passes the lock access requests to the locking unit.

8. The computer system of claim 1, wherein the guardian unit is integrated with the locking unit.

9. The computer system of claim 1, wherein the plurality of threads include one or more threads related to an application program and one or more threads related to external code that is external to the application program.

10. The computer system of claim 1, wherein the guardian unit is arranged to hold a plurality of the locking protocols, each of which relates to a corresponding plurality of the locks.

11. The computer system of claim 1, wherein the guardian unit is arranged to raise an exception when the requested lock is not consistent with the locking protocol.

12. The computer system of claim 11, further comprising a management console unit that produces an error report in response to the exception, wherein the error report identifies the requesting thread, the requested lock, and the locks which have already been granted to the requesting thread.

13. The computer system of claim 1, further comprising a testing tool arranged to exercise one or more code paths within an application program and to compare the lock access requests which arise on the one or more code paths against the predetermined locking protocol.

14. A method of controlling access to a shared resource in a computer system, comprising the steps of:
defining a locking protocol in relation to a plurality of locks that control access to the shared resource by a plurality of threads of execution of the computer system;
receiving a lock access request from one of the threads in relation to a requested lock amongst the plurality of locks;
selectively blocking the lock access request where, according to the locking protocol, the requested lock must not be granted after any of the locks which have already been granted to that thread, or else granting the requested lock to the thread and recording that the requested lock has been granted to the thread; and
repeating the receiving and selectively blocking steps for further lock access requests made by any of the plurality of threads in relation to any of the plurality of locks.

15. A computer-readable medium having recorded thereon instructions which, when implemented by a computer, cause the computer to perform the steps of:
defining a locking protocol in relation to a plurality of locks that control access to the shared resource by a plurality of threads of execution of the computer system;
receiving a lock access request from one of the threads in relation to a requested lock amongst the plurality of locks;
selectively blocking the lock access request where, according to the locking protocol, the requested lock must not be granted after any of the locks which have already been granted to that thread, or else granting the requested lock to the thread and recording that the requested lock has been granted to the thread; and
repeating the receiving and selectively blocking steps for all further lock access requests made by any of the plurality of threads in relation to any of the plurality of locks.
